(19) United States
(12) Patent Application Publication
(10) Pub. No.: US 2024/0282512 A1
(43) Pub. Date: Aug. 22, 2024

(54) TRANSFORMER, TRANSFORMER AS BOARD MOUNTING PART, AND MANUFACTURING METHOD THEREOF

(71) Applicant: Arata DAIKYUJI, Tokyo (JP)

(72) Inventor: Arata DAIKYUJI, Tokyo (JP)

(73) Assignee: MITSUMI ELECTRIC CO., LTD., Tokyo (JP)

(21) Appl. No.: 18/439,890

(22) Filed: Feb. 13, 2024

(30) Foreign Application Priority Data
Feb. 17, 2023 (JP) 2023-023583
Feb. 17, 2023 (JP) 2023-023584
Feb. 17, 2023 (JP) 2023-023585

(51) Int. Cl. H01F 27/36; H01F 27/02; H01F 27/26; H01F 27/28

(52) U.S. Cl. CPC H01F 27/363; H01F 27/02; H01F 27/26; H01F 27/2823

(57) ABSTRACT

A transformer in which a core portion has a hollow portion extending in a front-back direction, a conductive wire is wound around the core portion, a first core and a second core are formed by a material including a magnetic substance, and a shield case is formed by a material that has conductive properties, the shield case having a box shape surrounding the first core and the second core from a front-back direction, an up direction, and a left-right direction of the transformer, front convex portions and back convex portions being provided on an inner wall surface of the shield case and sandwiching the first core and the second core along the front-back direction, and left convex portions and right convex portions being provided on the inner wall surface of the shield case and sandwiching the first core and the second core along the left-right direction.

### INCORPORATION BY REFERENCE

This application is based upon, and claims the benefit of priority from, corresponding Japanese Patent Application No. 2023-023583 filed in the Japan Patent Office on Feb. 17, 2023, Japanese Patent Application No. 2023-023584 filed in the Japan Patent Office on Feb. 17, 2023, and Japanese Patent Application No. 2023-023585 filed in the Japan Patent Office on Feb. 17, 2023, the entire contents of which are incorporated herein by reference.

### BACKGROUND OF THE INVENTION

### Technical Field

The present disclosure relates to a transformer and a transformer as a board mounting part. The present disclosure also relates to a manufacturing method of a transformer and a transformer as a board mounting part.

### Background Art

An exemplary conventional transformer includes a core portion, a conductive wire, and a pair of cores. The core portion has a hollow portion therein, which extends in a first direction. The conductive wire is wound around the core portion. Each core is formed by a material that contains a magnetic substance. Each core includes an inner portion that extends from an end of the core portion in the first direction towards inside the hollow portion, and an outer portion that faces the conductive wire from a second direction that is orthogonal to the first direction. The pair of cores are aligned in the first direction so that their respective inner portions face each other and their respective outer portions face each other. The pair of cores are fixed by tape. In the above-described transformer, an interval (air gap) formed between the first core and the second core causes reduction in stability of inductance of the transformer. Therefore, positional displacement between both the cores of the transformer in the first direction has to be prevented by bringing the first core and the second core into strong contact with each other.

Furthermore, a conventional transformer includes a shield case, in a box shape, which accommodates therein the core and the conductive wire. The shield case includes an engagement piece. By an engagement piece being chalked to a base supporting a conductive terminal to which an end of the conductive wire is electrically coupled, any displacement of the shield case to a direction away from the base is restricted.

In addition, a transformer, as an example of the board mounting part, includes a base. The base supports the conductive terminal. The conductive terminal has a first portion and a second portion. The first portion is electrically coupled to a contact formed on the circuit board. The conductive wire used in the transformer is wound around the second portion. An electrical coupling is established between the conductive wire and the contact, by electrical connection established between the conductive wire and the second portion through soldering or laser welding.

It is requested to restrain reduction in stability of inductance of a conventional transformer. It is further requested to restrain reduction in performance of the board mounting part attributed to conduction failure in the transformer as the board mounting part.

### SUMMARY OF THE INVENTION

A first exemplary aspect of the present disclosure is a transformer including: a core portion having a hollow portion extending in a first direction; a conductive wire wound around the core portion; a first core formed by a material including a magnetic substance, the first core including: a first inner portion extending from one end of the core portion in the first direction to inside the hollow portion; and a first outer portion opposing the conductive wire, at least from a second direction orthogonal to the first direction, and a third direction orthogonal to the first direction and the second direction; a second core formed by a material including a magnetic substance, the second core including: a second inner portion extending from an other end of the core portion in the first direction to inside the hollow portion; and a second outer portion opposing the conductive wire from the second direction and the third direction; a shield case formed by a material that has conductive properties, and having a box shape surrounding the first core and the second core from the first direction, the second direction, and the third direction; and a sandwiching member provided on an inner wall surface of the shield case, and sandwiching the first core and the second core along the first direction.

A second exemplary aspect of the present disclosure is a transformer including: a core portion having a hollow portion extending in a first direction; a conductive wire wound around the core portion; a first core formed by a material including a magnetic substance, the first core including: a first inner portion extending from one end of the core portion in the first direction to inside the hollow portion; and a first outer portion opposing the conductive wire, at least from a second direction orthogonal to the first direction, and a third direction orthogonal to the first direction and the second direction; a second core formed by a material including a magnetic substance, the second core including: a second inner portion extending from an other end of the core portion in the first direction to inside the hollow portion; and a second outer portion opposing the conductive wire from the second direction and the third direction; a shield case formed by a material that has conductive properties, and having a box shape surrounding the first core and the second core from the first direction, the second direction, and the third direction; and a sandwiching member provided on an inner wall surface of the shield case, and sandwiching the first core and the second core along the second direction.

A third exemplary aspect of the present disclosure is a transformer including: a core portion having a hollow portion extending in a first direction; a conductive wire wound around the core portion; a first core formed by a material including a magnetic substance, the first core including: a first inner portion extending from one end of the core portion in the first direction to inside the hollow portion; and a first outer portion opposing the conductive wire, at least from a second direction orthogonal to the first direction, and a third direction orthogonal to the first direction and the second direction; a second core formed by a material including a magnetic substance, the second core including: a second inner portion extending from an other end of the core portion in the first direction to inside the hollow portion; and a second outer portion opposing the conductive wire from the second direction and the third direction; a shield case formed by a material that has conductive properties, and having a box shape surrounding the first core and the second core from the first direction, the second direction, and the third direction; a first sandwiching member provided on an inner wall surface of the shield case, and sandwiching the first core and the second core along the first direction; and a second sandwiching member provided on the inner wall surface, and sandwiching the first core and the second core along the second direction.

### BRIEF DESCRIPTION OF THE DRAWINGS

FIG. 1 is an exploded perspective view illustrating a configuration of a transformer according to an embodiment.

FIG. 2 illustrates an outer appearance of the transformer illustrated in FIG. 1, as viewed from an upper right front direction.

FIG. 3 illustrates an outer appearance of the transformer illustrated in FIG. 1, as viewed from a lower left back direction.

FIG. 4 illustrates an outer appearance of the transformer illustrated in FIG. 1, as viewed from below.

FIG. 5 illustrates a section as viewed from the direction of the arrows along the line V-V in FIG. 4.

FIG. 6 illustrates an outer appearance of the transformer illustrated in FIG. 1, as viewed from the right.

FIG. 7 illustrates a section as viewed from the direction of the arrows along the line VII-VII in FIG. 6.

FIG. 8 is a diagram for explaining a manufacturing method of the transformer illustrated in FIG. 1.

FIG. 9 is a diagram for explaining the manufacturing method of the transformer illustrated in FIG. 1.

FIG. 10 illustrates an example of a shape of a convex portion formed for a shield case illustrated in FIG. 9.

FIG. 11 illustrates another example of the shape of the convex portion formed for the shield case illustrated in FIG. 9.

FIG. 12 illustrates another example of the shape of the convex portion formed for the shield case illustrated in FIG. 9.

FIG. 13 illustrates another example of the shape of the convex portion formed for the shield case illustrated in FIG. 9.

FIG. 14 illustrates another example of the shape of the convex portion formed for the shield case illustrated in FIG. 9.

FIG. 15 illustrates another example of the shape of the convex portion formed for the shield case illustrated in FIG. 9.

FIG. 16 illustrates another example of the shape of the convex portion formed for the shield case illustrated in FIG. 9.

FIG. 17 illustrates an outer appearance of the convex portion illustrated in FIG. 16.

FIG. 18 is a diagram for explaining an other embodiment of the manufacturing method of the transformer illustrated in FIG. 1.

FIG. 19 is a diagram for explaining an other embodiment of the manufacturing method of the transformer illustrated in FIG. 1.

FIG. 20 is a diagram for explaining an other embodiment of the manufacturing method of the transformer illustrated in FIG. 1.

FIG. 21 is a welding method according to a first comparison example.

FIG. 22 is a welding method according to a second comparison example.

FIG. 23 is a diagram for explaining a further different embodiment of the manufacturing method of the transformer illustrated in FIG. 1.

FIG. 24 is a diagram for explaining a further different embodiment of the manufacturing method of the transformer illustrated in FIG. 1.

FIG. 25 is a diagram for explaining a further different embodiment of the manufacturing method of the transformer illustrated in FIG. 1.

FIG. 26 is a diagram for explaining a further different embodiment of the manufacturing method of the transformer illustrated in FIG. 1.

FIG. 27 illustrates a manufacturing method according to a comparison example.

FIG. 28 illustrates another example of a shape of a terminal for coil, in the transformer illustrated in FIG. 1.

FIG. 29 illustrates still another example of the shape of the terminal for coil, in the transformer illustrated in FIG. 1.

FIG. 30 illustrates an outer appearance of the transformer according to a further different embodiment of the manufacturing method of the transformer illustrated in FIG. 1, as viewed from an upper right front direction.

FIG. 31 illustrates a section of the transformer according to the further different embodiment of the manufacturing method of the transformer illustrated in FIG. 1, as viewed from the direction of the arrows along the line V-V in FIG. 4.

FIG. 32 is a perspective view illustrating a design of the transformer according to FIG. 1 to FIG. 9.

FIG. 33 is a front view illustrating the design of the transformer illustrated in FIG. 30.

FIG. 34 is a back view illustrating the design of the transformer illustrated in FIG. 30.

FIG. 35 is a plan view illustrating the design of the transformer illustrated in FIG. 30.

FIG. 36 is a bottom view illustrating the design of the transformer illustrated in FIG. 30.

FIG. 37 is a left-side view illustrating the design of the transformer illustrated in FIG. 30.

FIG. 38 is a right-side view illustrating the design of the transformer illustrated in FIG. 30.

### DESCRIPTION OF THE EMBODIMENTS

The following describes exemplary embodiments with reference to the attached drawings. In the attached drawings, the arrow F indicates a front direction of the illustrated structure. The arrow B indicates a back direction of the illustrated structure. The arrow U indicates an up direction of the illustrated structure. The arrow D indicates a down direction of the illustrated structure. The arrow R indicates a right direction of the illustrated drawing. The arrow L indicates a left direction of the illustrated structure.

These expressions related to the directions are rendered only for the explanation, and do not limit the posture, direction, or the like of the illustrated structures in the actual usage conditions.

The term “front-back direction” used in the present specification indicates a direction which is along the above-explained front direction and back direction. The term “up-down direction” used in the present specification indicates a direction which is along the above-explained up direction and down direction. The term “left-right direction” used in the present specification indicates a direction which is along the above-explained left direction and right direction.

The expression “extends in a/the front-back direction” used in the present specification includes extension, by tilting, toward the front-back direction, and means to extend, by tilting, closer toward the front-back direction than toward the up-down direction and the left-right direction.

The expression “extends in a/the up-down direction” used in the present specification includes extension, by tilting, toward the up-down direction, and means to extend, by tilting, closer toward the up-down direction than toward the front-back direction and the left-right direction.

The expression “extends in a/the left-right direction” used in the present specification includes extension, by tilting, toward the left-right direction, and means to extend, by tilting, closer toward the left-right direction than toward the front-back direction and the up-down direction.

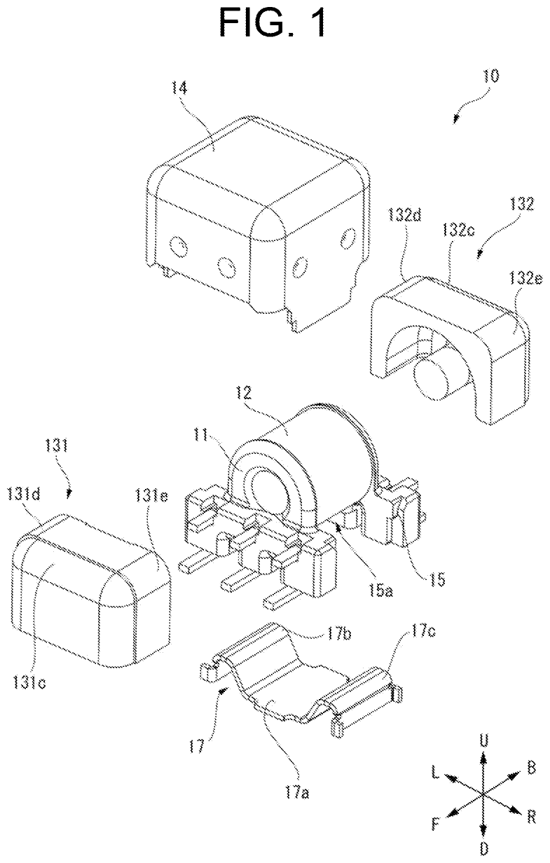

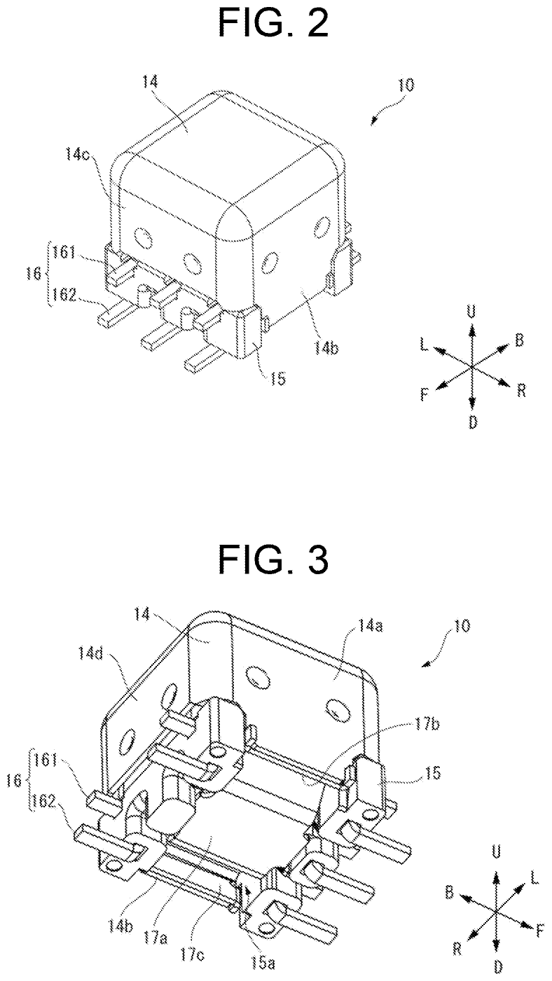

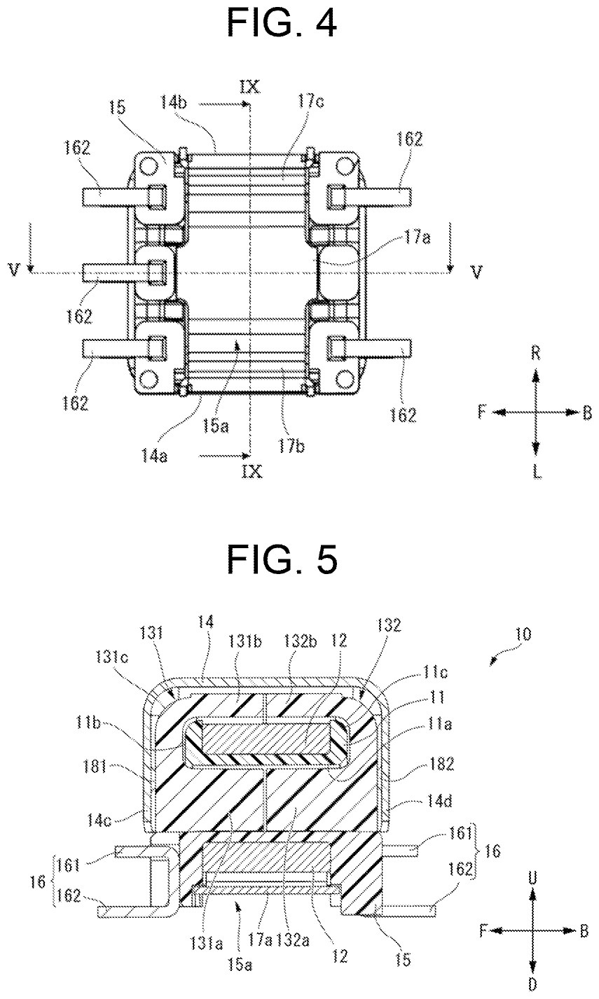

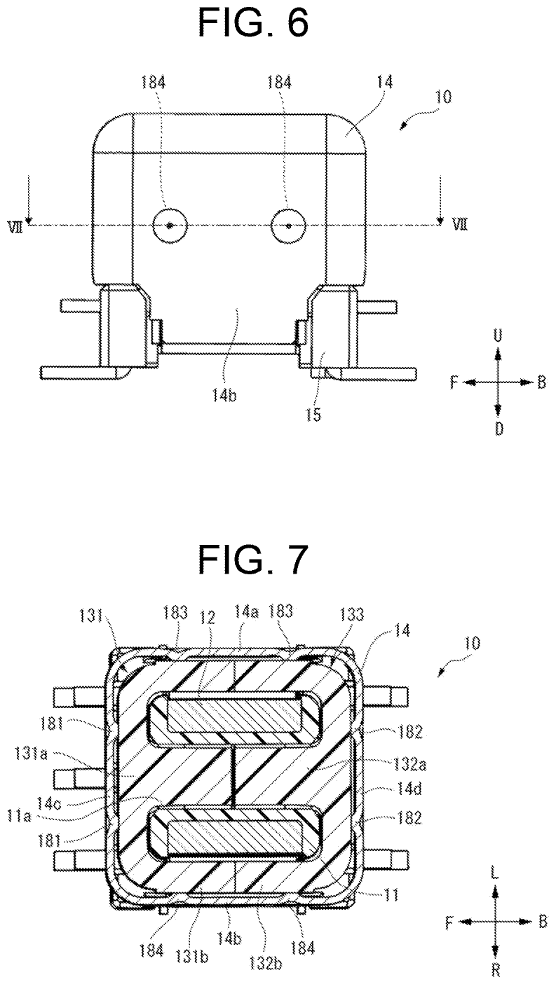

FIG. 1 is an exploded perspective view illustrating an outer appearance of a transformer 10 according to an embodiment. FIG. 2 illustrates an outer appearance of the transformer 10 illustrated in FIG. 1, as viewed from an upper right front direction. FIG. 3 illustrates an outer appearance of the transformer 10 illustrated in FIG. 1, as viewed from a lower left back direction. FIG. 4 illustrates an outer appearance of the transformer 10 illustrated in FIG. 1, as viewed from below. FIG. 5 illustrates a section of the transformer 10 as viewed from the direction of the arrows along the line V-V in FIG. 4. FIG. 6 illustrates an outer appearance of the transformer 10, as viewed from the right. FIG. 7 illustrates a section of the transformer 10 as viewed from the direction of the arrows along the line VII-VII in FIG. 6.

As illustrated in FIG. 1, FIG. 5, and FIG. 7, the transformer 10 includes a core portion 11 and a conductive wire 12. The core portion 11 is formed by a material that has electrical insulation properties, and has a hollow portion 11a which extends in the front-back direction. The conductive wire 12 forms a coil by being wound around the core portion 11. The front-back direction is an example of a first direction.

The transformer 10 includes a first core 131. The first core 131 is formed by a material that includes a magnetic substance. An example of the material is ferrite.

The first core 131 includes a first inner portion 131a and a first outer portion 131b. The first inner portion 131a extends from a front end of the core portion 11 to inside the hollow portion 11a. The first outer portion 131b opposes the conductive wire 12 from the up direction and the left-right direction. The front end is an example of one end in the first direction of the core portion 11. The left-right direction is an example of a second direction. The up direction is an example of a third direction.

The transformer 10 includes a second core 132. The second core 132 is formed by a material that includes a magnetic substance. An example of the material is ferrite.

The second core 132 includes a second inner portion 132a and a second outer portion 132b. The second inner portion 132a extends from a back end of the core portion 11 to inside the hollow portion 11a. The second outer portion 132b opposes the conductive wire 12 from the up direction and the left-right direction. The back end is an example of an other end in the first direction of the core portion 11.

As illustrated in FIG. 1 to FIG. 7, the transformer 10 includes a shield case 14. The shield case 14 is formed by a material that has conductive properties. Some examples of the conductive material are aluminum and copper. The shield case 14 is provided to restrain electromotive forces which would be generated in the conductive wire 12 by the magnetic field as a noise to occur from outside the transformer 10. The shield case 14 has a box shape to surround the first core 131 and the second core 132 from the front-back direction, the up direction, and the left-right direction.

As illustrated in FIG. 1 to FIG. 3, the transformer 10 includes a base 15 and a plurality of terminals 16. The base 15 is formed by a material that has electrical insulation properties. The base 15 is integrally formed with the core portion 11. Each of the plurality of terminals 16 is formed by a material that has a material that has conductive properties.

Each of the plurality of terminals 16 is integrally formed with the base 15. Each of the plurality of terminals 16 includes a terminal for coil 161 and a terminal for mounting 162. An end (not illustrated) of the conductive wire 12 wound around the core portion 11 is electrically coupled with the terminal for coil 161. The terminal for mounting 162 is electrically coupled to circuitry element (s) formed on a circuit board when the transformer 10 is mounted on the circuit board. By doing so, the conductive wire 12 and the circuitry element (s) on the circuit board are electrically coupled to each other.

As illustrated in FIG. 1, the transformer 10 includes a shield plate 17. The shield plate 17 is formed by a material that has conductive properties. Preferably, the shield plate 17 is formed by a material that is the same as the material of the shield case 14.

The shield plate 17 includes a first portion 17a. As illustrated in FIG. 5, the first portion 17a is disposed to oppose the conductive wire 12 from the down direction. When the transformer 10 is mounted on the circuit board, the first portion 17a is disposed between the conductive wire 12 and the circuit board.

As illustrated in FIG. 1, FIG. 3, and FIG. 4, the shield plate 17 has an elongated shape in the left-right direction. The shield plate 17 includes a second portion 17b and a third portion 17c. The second portion 17b extends continually from a left end of the first portion 17a, and is inseparably coupled to a left-side wall 14a of the shield case 14. The third portion 17c extends continually from a right end of the first portion 17a, and is inseparably coupled to a right-side wall 14b of the shield case 14.

On the other hand, the base 15 is shaped to partition a space 15a. The space 15a is shaped to be able to receive the shield plate 17 coupled to the shield case 14.

The shield case 14 has a box shape which opens in the down direction. Therefore, the shield case 14 cannot cover the conductive wire 12 from the down direction. However, by provision of the shield plate 17, the transformer 10 can allocate a portion to surround the conductive wire 12 from an outer side in a radial direction of the core portion 11. In other words, the shield plate 17 can restrain electromotive forces which would be generated in the conductive wire 12 by the magnetic field as a noise to occur from below the transformer 10.

As illustrated in FIG. 7, an inner wall surface of a front-side wall 14c of the shield case 14 is provided with a pair of front convex portions 181. Each front convex portion 181 is in contact with the first core 131. On the other hand, an inner wall surface of a back-side wall 14d of the shield case 14 is provided with a pair of back convex portions 182. Each back convex portion 182 is in contact with the second core 132.

As a result, the first core 131 and the second core 132 are sandwiched by the pair of front convex portions 181 and the pair of back convex portions 182, along the front-back direction. The pair of front convex portions 181 and the pair of back convex portions 182 are examples of a first sandwiching member.

The pair of front convex portions 181 may be formed, for example, by performing punching from outside the front-side wall 14c of the shield case 14. Accordingly, as illustrated in FIG. 2, the front-side wall 14c is provided with a pair of concave portions.

Likewise, the pair of back convex portions 182 may be formed, for example, by performing punching from outside the back-side wall 14d of the shield case 14. Accordingly, as illustrated in FIG. 3, the back-side wall 14d is provided with a pair of concave portions.

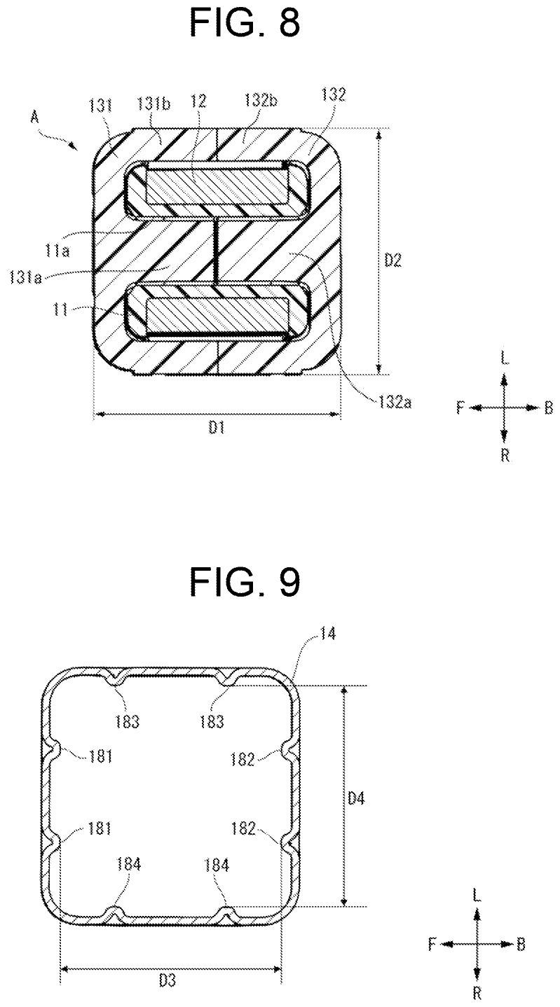

FIG. 8 illustrates an assembly A, in which the first core 131 and the second core 132 are mounted to the core portion 11, extracted from FIG. 7. The first inner portion 131a of the first core 131 and the second inner portion 132a of the second core 132 oppose each other in the front-back direction, within the hollow portion 11a of the core portion 11. The first outer portion 131b of the first core 131 and the second outer portion 132b of the second core 132 oppose each other in the front-back direction, outside the core portion 11.

The assembly A is formed after an adhesive is applied to at least between the first inner portion 131a and the second inner portion 132a.

FIG. 9 illustrates a section, at a position corresponding to FIG. 7, of the shield case 14 immediately after the front convex portions 181 and the back convex portions 182 are formed. An interval D3 between the front convex portion 181 and the back convex portion 182 in the front-back direction of the transformer 10 is smaller than a size D1 of the assembly A in the same direction.

Before the adhesive applied between the first core 131 and the second core 132 is cured, the shield case 14 is mounted to the assembly A from above. Accordingly, the core portion 11, the first core 131, and the second core 132 are accommodated in the shield case 14.

Because the interval D3 between the front convex portion 181 and the back convex portion 182 in the front-back direction of the transformer 10 is smaller than the size D1 of the assembly A in the same direction, the front convex portions 181 are deformed as if to collapse forward, thereby to press the first core 131 backward. Likewise, the back convex portions 182 are deformed as if to collapse backward, thereby press the second core 132 forward. As a result, the front convex portions 181 and the back convex portions 182 sandwich the first core 131 and the second core 132 along the front-back direction of the transformer 10.

An interval (air gap) formed between the first core 131 and the second core 132 causes reduction in stability of inductance of the transformer 10. Therefore, positional displacement between both the cores of the transformer 10 in the front-back direction has to be prevented by bringing the first core 131 and the second core 132 into strong contact with each other.

According to the configuration of the present exemplary embodiment, by accommodating the core portion 11, the first core 131, and the second core 132 in the shield case 14, the front convex portions 181 and the back convex portions 182 can sandwich the first core 131 and the second core 132, thereby forming a state in which both cores are in strong contact with each other. Accordingly, it becomes possible to restrain reduction in stability of inductance attributed to positional displacement between the first core 131 and the second core 132 in the front-back direction of the transformer 10.

In addition, when the first core 131 and the second core 132 are fixed using an adhesive, for example, the front convex portions 181 and the back convex portions 182 provided in the shield case 14, being a component of the transformer 10, are used to play a role of forming a state in which the first core 131 and the second core 132 are in strong contact with each other; and therefore no jig dedicated to sandwich the first core 131 and the second core 132 is required until the adhesive is cured. Therefore, complexity of a manufacturing process and a manufacturing facility of the transformer 10 is restrained.

As illustrated in FIG. 7, an inner wall surface of the left-side wall 14a of the shield case 14 is provided with a pair of left convex portions 183. The left convex portion 183 which is closer to the front-side wall 14c is in contact with the first core 131. The left convex portion 183 which is closer to the back-side wall 14d is in contact with the second core 132.

On the other hand, an inner wall surface of the right-side wall 14b of the shield case 14 is provided with a pair of right convex portions 184. The right convex portion 184 which is closer front-side wall 14c is in contact with the first core 131. The right convex portion 184 which is closer to the back-side wall 14d is in contact with the second core 132.

As a result, along the left-right direction, the first core 131 and the second core 132 are sandwiched by the left convex portions 183 and the right convex portions 184. The pair of left convex portions 183 and the pair of right convex portions 184 are examples of a second sandwiching member. The pair of left convex portions 183 may be formed by performing punching from outside the left-side wall 14a of the shield case 14, for example. Accordingly, as illustrated in FIG. 3, the left-side wall 14a may be provided with a pair of concave portions.

Likewise, the pair of right convex portions 184 may be formed by performing punching from outside the right-side wall 14b of the shield case 14, for example. Accordingly, as illustrated in FIG. 2, the right-side wall 14b is provided with a pair of concave portions.

As illustrated in FIG. 9, immediately after the left convex portions 183 and the right convex portions 184 are formed, the interval D4 in the direction of the left convex portion 183 and the right convex portion 184 in the left-right direction of the transformer 10 is smaller than the size D2 of the assembly A in the same direction.

Therefore, when the shield case 14 is mounted to the assembly A from above, before the adhesive applied between the first core 131 and the second core 132 is cured, the left convex portions 183 are deformed as if to collapse leftward, thereby to press the first core 131 and the second core 132 rightward. Likewise, the right convex portions 184 are deformed as if to collapse rightward, thereby to press the first core 131 and the second core 132 leftward. As a result, the pair of left convex portions 183 and the pair of right convex portions 184 sandwich the first core 131 and the second core 132 along the left-right direction of the transformer 10.

A shaft misalignment of the first core 131 and the second core 132 in the left-right direction of the transformer 10 causes reduction in stability of inductance of the transformer 10. According to the configuration of the present exemplary embodiment, by accommodating the core portion 11, the first core 131, and the second core 132 in the shield case 14, the left convex portions 183 and the right convex portions 184 sandwich the first core 131 and the second core 132, thereby realizing positioning which can resolve the shaft misalignment between the first core 131 and the second core 132 in the left-right direction of the transformer 10. Accordingly, it becomes possible to restrain reduction in stability of inductance attributed to positional displacement between the first core 131 and the second core 132 in the left-right direction of the transformer 10.

In addition, when the first core 131 and the second core 132 are fixed using an adhesive, for example, the left convex portions 183 and the right convex portions 184 provided in the shield case 14, being a component of the transformer 10, are used to play a role of resolving the shaft misalignment between the first core 131 and the second core 132; and therefore no jig dedicated to sandwich the first core 131 and the second core 132 is required until the adhesive is cured. Therefore, complexity of a manufacturing process and a manufacturing facility of the transformer 10 is restrained.

It should be noted that as long as such positioning can be realized, which resolves the shaft misalignment between the first core 131 and the second core 132 in the left-right direction of the transformer 10, the interval D4 in the direction of the left convex portion 183 and the right convex portion 184 in the left-right direction of the transformer 10 may be equal to the size D2 of the assembly A in the same direction.

Either one of: a combination of the front convex portions 181 and the back convex portions 182; or a combination of the left convex portions 183 and the right convex portions 184 can be omitted. However, if both are provided as in the present exemplary embodiment, when the first core 131 and the second core 132 are fixed using an adhesive, for example, it is possible to, until the adhesive is cured, form a state in which the first core 131 and the second core 132 are in strong contact with each other in the front-back direction of the transformer 10 as well as resolve the shaft misalignment between the first core 131 and the second core 132 in the left-right direction of the transformer 10. Accordingly, it is possible to avoid any shaft misalignment that would occur between both the cores if a jig dedicated for realizing a strong contact state is used to hold the first core 131 and the second core 132.

If, as in the present exemplary embodiment, a relative position between the core portion 11 and the base 15, to which the first core 131 and the second core 132 are coupled, is invariable, the base 15 is positioned relative to the shield case 14 in the front-back direction of the transformer 10, by accommodating the core portion 11, the first core 131, and the second core 132 in the shield case 14, thereby to sandwich the first core 131 and the second core 132 by the front convex portions 181 and the back convex portions 182.

If a relative position between the shield case 14 and the base 15 in the front-back direction of the transformer 10 is unstable, interference is possibly caused between the shield plate 17 and the base 15, which are to be received in the space 15a for coupling with the shield case 14 at least in the same direction. So as to avoid such interference, either reduction of a width size of the shield plate 17 in the front-back direction of the transformer 10 becomes necessary, or a positioning process of the shield plate 17 relative to the base 15 becomes complex.

According to the configuration of the present exemplary embodiment, there is no need to reduce the width size of the shield plate 17 in the front-back direction of the transformer 10, and it is therefore possible to restrain reduction in shielding function due to area reduction of the shield plate 17. In addition, complexity of the positioning process of the shield plate 17 relative to the base 15 is restrained, which enables efficient manufacturing of the transformer 10.

Likewise, if the core portion 11, the first core 131, and the second core 132 are accommodated in the shield case 14, the first core 131 and the second core 132 are sandwiched by the left convex portions 183 and the right convex portions 184, thereby realizing positioning of the base 15 relative to the shield case 14 in the left-right direction of the transformer 10.

If a relative position between the shield case 14 and the base 15 in the left-right direction of the transformer 10 is unstable, interference is possibly caused between the shield plate 17 and the base 15 to be received in the space 15a for coupling with the shield case 14 at least in the same direction. So as to avoid such interference, either omission of a pair of protrusions protruding in the front-back direction of the transformer 10 in the first portion 17a of the shield plate 17 becomes necessary, or the positioning process of the shield plate 17 relative to the shield case 14 becomes complex.

According to the configuration of the present exemplary embodiment, there is no need to omit any protrusion provided for the first portion 17a of the shield plate 17, and it is therefore possible to restrain reduction in shielding function due to area reduction of the shield plate 17. In addition, complexity of the positioning process of the shield plate 17 relative to the shield case 14 is restrained, which enables efficient manufacturing of the transformer 10.

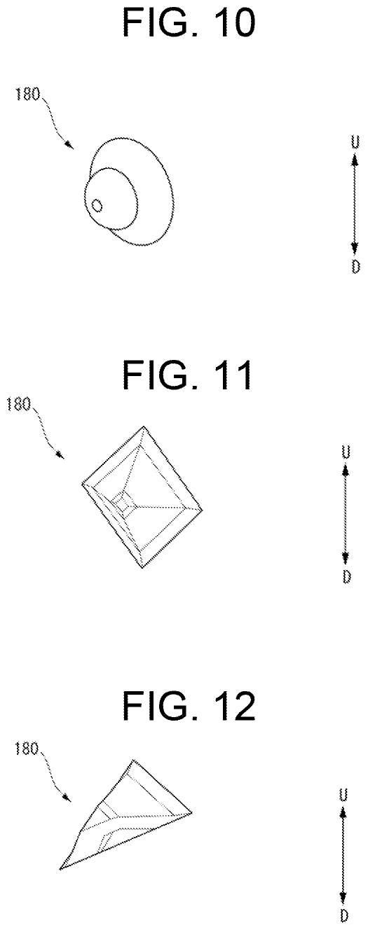

The following describes examples of shapes of the front convex portion 181, the back convex portion 182, the left convex portion 183, and the right convex portion 184, with reference to FIG. 10 to FIG. 17. In the following description, the front convex portion 181, the back convex portion 182, the left convex portion 183, and the right convex portion 184 are collectively referred to as “convex portion 180” as needed.

FIG. 10 illustrates a shape of a convex portion 180 in the exemplary embodiment described with reference to FIG. 1 to FIG. 9. The convex portion 180 in the present example has a dome shape symmetrical with respect to the up-down direction and either the left-right direction or the front-back direction.

FIG. 11 illustrates another example of the shape of the convex portion 180. The convex portion 180 according to the present example has a pyramidal shape symmetrical with respect to the up-down direction and either the left-right direction or the front-back direction.

FIG. 12 illustrates another example of the shape of the convex portion 180. The convex portion 180 according to the present example is formed by punching a die, having a triangular sectional shape, from outside a side wall of the shield case 14. The portion of the convex portion 180 corresponding to the bottom side of the triangle protrudes inside the shield case 14 due to punching through from the side wall. The portion of the convex portion 180 corresponding to the remaining two sides of the triangle maintains the state connected to the inner wall surface of the shield case 14.

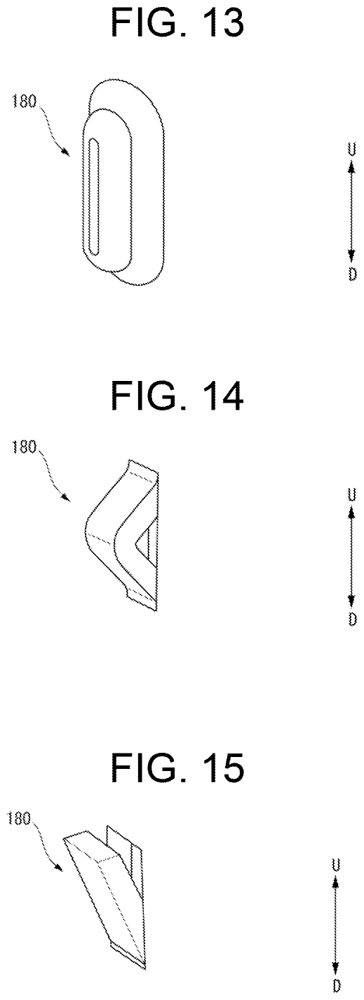

FIG. 13 illustrates another example of the shape of the convex portion 180. The convex portion 180 according to the present example has a dome shape which is elongated in the up-down direction.

FIG. 14 illustrates another example of the shape of the convex portion 180. The convex portion 180 according to the present example is formed by punching a die, having a rectangular sectional shape with the up-down direction being the longer direction, from outside a side wall of the shield case 14, to be elongated in the up-down direction. The portion of the convex portion 180 corresponding to the long side of the rectangle protrudes inside the shield case 14 due to punching through from the side wall. The portion of the convex portion 180 corresponding to the short side of the rectangle maintains the state connected to the inner wall surface of the shield case 14.

The convex portion 180 according to the present example is formed by punching a die, having a rectangular sectional shape with the up-down direction being the longer direction, from outside a side wall of the shield case 14, to have a shape of a cantilever beam which is elongated in the up-down direction. Of the convex portion 18, the portion corresponding to the long side of the rectangle and the portion corresponding to the upper short side protrude inside the shield case 14 due to punching through from the side wall. The portion of the convex portion 180 corresponding to the lower short side of the rectangle maintains the state connected to the inner wall surface of the shield case 14.

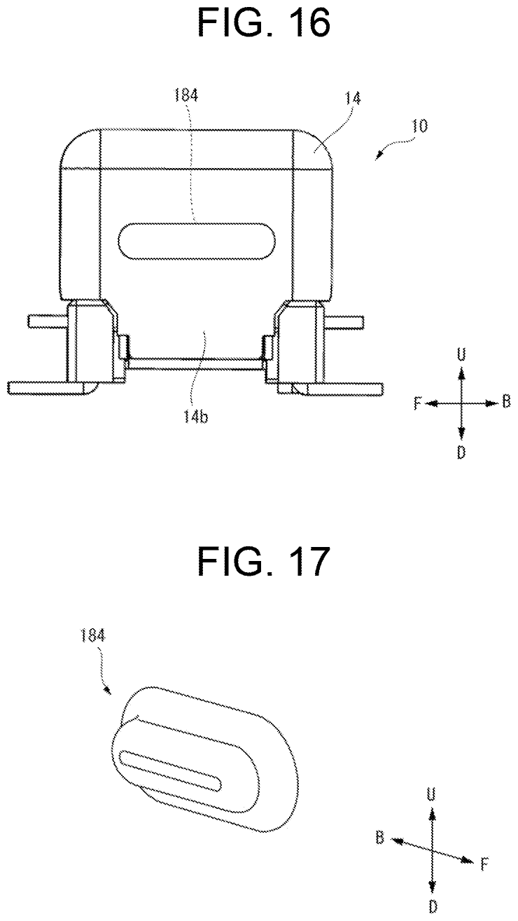

In the exemplary embodiment described with reference to FIG. 1 to FIG. 9, the right-side wall 14b of the shield case 14 is provided with the pair of right convex portions 184. One of the right convex portions 184 is in contact with the first core 131, and the other one of the right convex portions 184 is in contact with the second core 132. However, as illustrated in FIG. 16, a single right convex portion 184, having an elongated shape in the front-back direction of the transformer 10 may be provided on the right-side wall 14b. FIG. 17 illustrates an outer appearance of the single right convex portion 184, as viewed from inside the shield case 14. In this case, the single right convex portion 184 is in contact with both of the first core 131 and the second core 132. Although not illustrated in the drawings, a single left convex portion 183, having an elongated shape in the front-back direction of the transformer 10, may be provided on the left-side wall 14a.

If at least one pair of the pair of left convex portions 183 and the pair of right convex portions 184, having been described with reference to FIG. 1 to FIG. 9, is configured as a single convex portion extending in the front-back direction to straddle over the first core 131 and the second core 132 as described above, collective adjustment of the first core 131 and the second core 132 becomes possible in the left-right direction of the transformer 10. Accordingly, resolution of the shaft misalignment between the first core 131 and the second core 132 in the same direction can be facilitated.

As illustrated in FIG. 1 and FIG. 5, a corner portion of the first outer portion 131b of the first core 131, which opposes the front-side wall 14c of the shield case 14, is formed as a rounded corner portion 131c having a curved surface. Likewise, a corner portion of the second outer portion 132b of the second core 132, which opposes the back-side wall 14d of the shield case 14, is formed as a rounded corner portion 132c having a curved surface.

According to the above-described configuration, when the shield case 14 is mounted from above, the front convex portions 181 and the back convex portions 182 may be respectively guided to the curved surfaces of the rounded corner portion 131c and the rounded corner portion 132c. Accordingly, the front convex portions 181 and the back convex portions 182 can be smoothly guided to the positions at which the first core 131 and the second core 132 are sandwiched from the front-back direction of the transformer 10. In addition, accidental deformation of at least one of the front convex portions 181 and the back convex portions 182 attributed to interference between at least one of the first core 131 and the second core 132 with respect to the shield case 14 is restrained, thereby restraining reduction in positional regulation capability of the transformer 10 in the front-back direction with respect to the first core 131 and the second core 132.

As illustrated in FIG. 1, a corner portion of the first outer portion 131b of the first core 131, which opposes the left-side wall 14a of the shield case 14, is formed as a rounded corner portion 131d having a curved surface. A corner portion of the first outer portion 131b of the first core 131, which opposes the right-side wall 14b of the shield case 14, is formed as a rounded corner portion 131e having a curved surface.

According to the above-described configuration, when the shield case 14 is mounted from above, the left convex portions 183 and the right convex portions 184 may be respectively guided to the curved surfaces of the rounded corner portion 131d and the rounded corner portion 131e. Accordingly, the left convex portions 183 and the right convex portions 184 can be smoothly guided to the position at which the first core 131 is sandwiched from the left-right direction of the transformer 10. In addition, accidental deformation of at least one of the left convex portions 183 and the right convex portion 184 attributed to interference between the first core 131 with respect to the shield case 14 is restrained, thereby restraining reduction in positional regulation capability of the transformer 10 in the left-right direction with respect to the first core 131.

Likewise, a corner portion of the second outer portion 132b of the second core 132, which opposes the left-side wall 14a of the shield case 14, is formed as a rounded corner portion 132d having a curved surface. A corner portion of the second outer portion 132b of the second core 132, which opposes the right-side wall 14b of the shield case 14, is formed as a rounded corner portion 132e having a curved surface.

According to the above-described configuration, when the shield case 14 is mounted from above, the left convex portions 183 and the right convex portions 184 may be respectively guided to the curved surfaces of the rounded corner portion 132d and the rounded corner portion 132e. Accordingly, the left convex portions 183 and the right convex portions 184 can be smoothly guided to the position at which the second core 132 is sandwiched from the left-right direction of the transformer 10. In addition, accidental deformation of at least one of the left convex portions 183 and the right convex portions 184 attributed to interference between the second core 132 with respect to the shield case 14 is restrained, thereby restraining reduction in positional regulation capability of the transformer 10 in the left-right direction with respect to the second core 132.

The shield case 14 may be formed to have a slitless box shape by drawing. In other words, the shield case 14 may be a one-piece part formed by drawing a plate material. The term “one-piece part” used in the present specification means a part having a monolithic structure. The term “one-piece part” is used to distinguish this from a part integrally formed by coupling a plurality of parts in various methods. Examples of the various methods include glueing, bonding, weld-depositing, welding, engaging, interdigitation, and screwing.

According to the above-described configuration, rigidity of the shield case 14 can be enhanced, which can facilitate provision and maintenance of required fastening force to the first core 131 and the second core 132. In addition, relative rigidity of the shield case 14 relative to the convex portion 180 can be enhanced, thereby facilitating deformation of only the convex portion 180 when mounting the shield case 14 to the first core 131 and the second core 132. As a result, a process to accommodate the core portion 11, first core 131, and second core 132 within the shield case 14 can be smoothly pursued.

As described above, the second portion 17b of the shield plate 17 extends continually from the left end of the first portion 17a, and is inseparably coupled to the left-side wall 14a of the shield case 14. In addition, the third portion 17c extends continually from the right end of the first portion 17a, and is inseparably coupled to the right-side wall 14b of the shield case 14. An embodiment in which this inseparable coupling is performed by welding is described below with reference to the drawings.

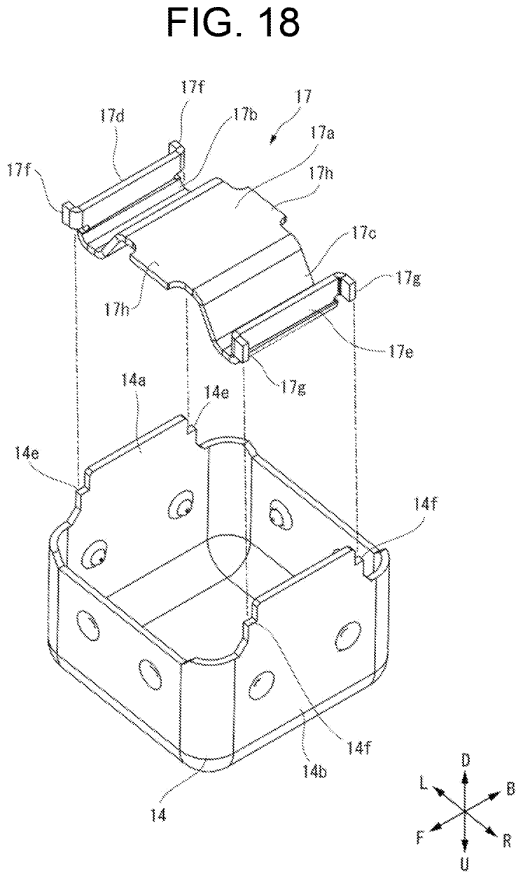

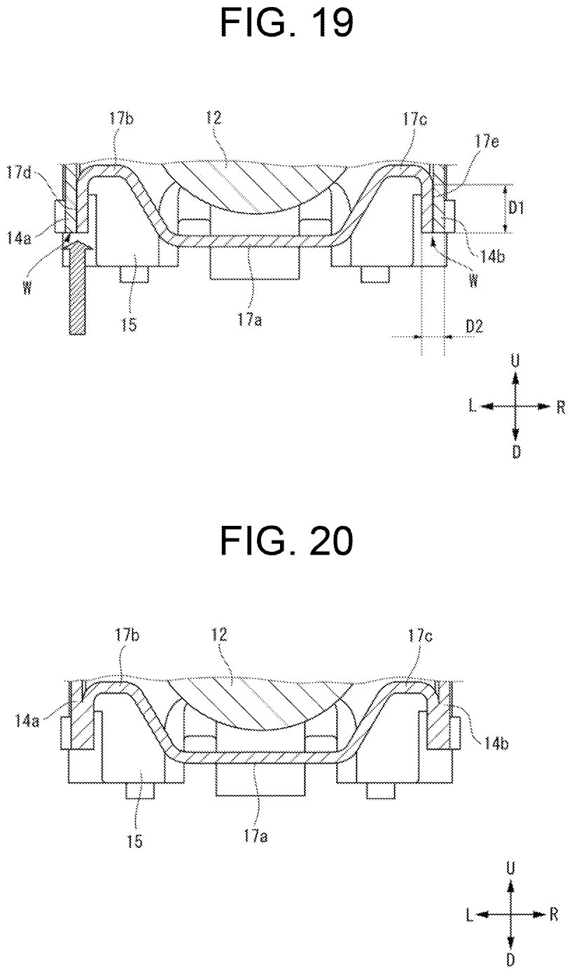

FIG. 18 illustrates a positional relation between the shield case 14 and the shield plate 17. Although not illustrated in the drawings, the shield case 14 accommodates therein an assembly to which the core portion 11, the conductive wire 12, the first core 131, the second core 132, the base 15, and a terminal 16 are coupled. FIG. 19 illustrates an enlarged section as viewed from the direction of the arrows along the line IX-IX of the shield plate 17 in FIG. 4.

As illustrated in FIG. 18, the second portion 17b of the shield plate 17 includes a contact surface 17d. The contact surface 17d is formed on a left end of the second portion 17b, and has an elongated shape in the front-back direction. Likewise, the third portion 17c of the shield plate 17 includes a contact surface 17e. The contact surface 17e is formed on a right end of the third portion 17c, and has an elongated shape in the front-back direction.

When the first portion 17a of the shield plate 17 is disposed to oppose the conductive wire 12 in the up direction, as illustrated in FIG. 19, the contact surface 17d of the second portion 17b contacts an inner surface of the left-side wall 14a of the shield case 14 in the left-right direction. The left-right direction is an example of a third direction. At this time, a lower end edge of the left-side wall 14a and a front end edge of the second portion 17b form a welded surface W. The welded surface W faces the down direction.

Likewise, the contact surface 17e of the third portion 17c contacts an inner surface of the right-side wall 14b of the shield case 14 in the left-right direction. At this time, a lower end edge of the right-side wall 14b and a front end edge of the third portion 17c form a welded surface W. The welded surface W faces the down direction.

Subsequently, as illustrated as the arrow in FIG. 19, the welded surface W is irradiated with laser light, thereby welding the shield case 14 and the shield plate 17, as illustrated in FIG. 20. Note that TIG welding may be used in place of laser welding.

In the present exemplary embodiment, the shield plate 17 is assembled to the shield case 14 so that the welded surface W faces the down direction. However, the direction of the welded surface W during an assembly process and a welding process may be changed as necessary depending on the specification of the manufacturing apparatus.

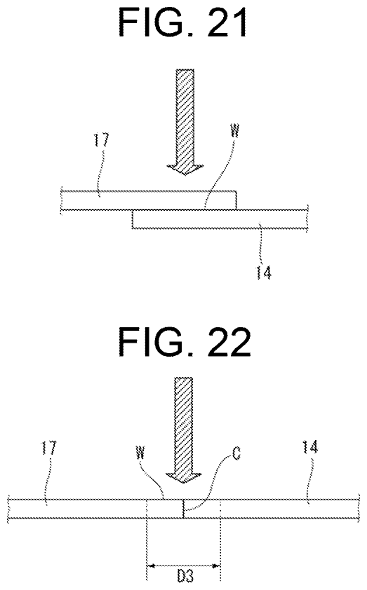

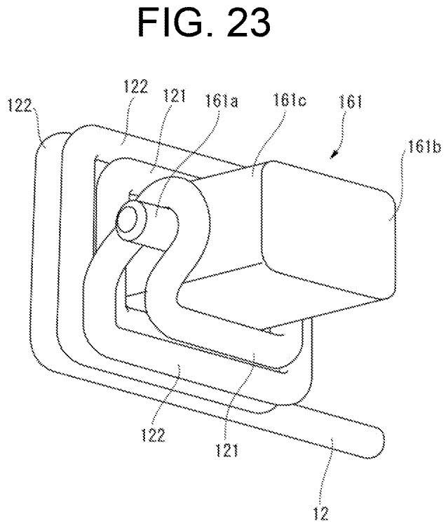

As illustrated in FIG. 19, the direction which the welded surface W faces intersects the direction in which the shield case 14 is in contact with the shield plate 17. In addition, the size D1 of each of the contact surface 17d and the contact surface 17e along the down direction (the direction which the welded surface W faces) is longer than the size D2 of the welded surface W along the left-right direction (the direction that intersects the direction which the welded surface W faces). The following describes advantages of this configuration with reference to FIG. 21 and FIG. 22.

In a first comparison example illustrated in FIG. 21, the direction which the welded surface W faces matches the direction in which the shield case 14 is in contact with the shield plate 17. That is, the contact surface between the shield case 14 and the shield plate 17 forms the welded surface W. In the configuration according to the present example, since the welded surface W cannot be directly observed, it is difficult to confirm the state of finishing of the welding.

In a second comparison example illustrated in FIG. 22, the direction which the welded surface W faces intersects the direction in which the shield case 14 is in contact with the shield plate 17. However, the size of the contact surface C between the shield case 14 and the shield plate 17 along the direction which the welded surface W faces is smaller than the size D3 of the welded surface W along the direction intersecting this direction. In the configuration according to the present example, although the welded surface W can be directly observed, it is difficult to secure rigidity especially against the stress in the direction to separate the contact surfaces from each other.

According to the configuration of the present exemplary embodiment, having been described with reference to FIG. 19, it is easy to confirm the state of finishing of the welding, since the welded surface W can be directly observed. In addition, rigidity against the stress in the direction to separate the contact surfaces from each other can be enhanced. Therefore, a stable coupling state of the shield plate 17 with respect to the shield case 14 can be realized. As described so far, the shield plate 17 can restrain electromotive forces which would be generated in the conductive wire 12 by the magnetic field as a noise to occur from below the transformer 10. By restraining the positional displacement of this shield plate 17 with respect to the shield case 14, it becomes possible to restrain reduction in stability of inductance in the transformer 10.

An example of an other method to couple the shield plate 17 to the shield case 14 is a reflow solder bonding. However, increase in manufacturing cost is inevitable due to material costs for solder pasts and necessity to manage thermal loads to the terminal 16 during a reflow process. On the other hand, the welding process according to the present exemplary embodiment is performed by a comparatively simple apparatus configuration and can locally heat and process the welded surface W, which has const advantages over the reflow solder bonding. As a result, it is possible to restrain reduction in stability of inductance while restraining increase in manufacturing cost of the transformer 10.

As illustrated in FIG. 19, the welded surface W formed by the left-side wall 14a of the shield case 14 and the second portion 17b of the shield plate 17, and the welded surface W formed by the right-side wall 14b of the shield case 14 and the third portion 17c of the shield plate 17 face the same down direction.

In this way, since the plurality of welded surfaces W face the same direction, a welding work can be pursued from the same direction. Accordingly, the manufacturing apparatus and the manufacturing process can be simplified, which can restrain increase in manufacturing cost of the transformer 10.

As illustrated in FIG. 18, the left-side wall 14a of the shield case 14 includes a pair of step portions 14e. The pair of step portions 14e are formed at both ends in the front-back direction of the left-side wall 14a. Each of the step portions 14e has a regulation surface that faces the down direction.

On the other hand, the second portion 17b of the shield plate 17 includes a pair of engagement portions 17f. The pair of engagement portions 17f are formed as arm portions that extend leftward at both ends in the front-back direction of the contact surface 17d.

Likewise, the right-side wall 14b of the shield case 14 includes a pair of step portions 14f. The pair of step portions 14f are formed at both ends in the front-back direction of the right-side wall 14b. Each of the step portions 14f has a regulation surface that faces the down direction.

On the other hand, the third portion 17c of the shield plate 17 includes a pair of engagement portions 17g. The pair of engagement portions 17g are formed as arm portions that extend rightward at both ends in the front-back direction of the contact surface 17e.

When the shield plate 17 is assembled to the shield case 14, the pair of engagement portions 17f abut the regulation surfaces of the pair of step portions 14e. The position of the regulation surfaces is set such that, by abutting of the engagement portions 17f against the regulation surfaces, the welded surface W formed by the left-side wall 14a of the shield case 14 and the second portion 17b of the shield plate 17 is defined. Preferably, the welded surface W is defined so that the lower end edge of the left-side wall 14a and the front end edge of the second portion 17b form the same plane. The pair of engagement portions 17f are an example of a positioning portion.

Likewise, the pair of engagement portions 17g abut the regulation surfaces of the pair of step portions 14f. The position of the regulation surfaces is set such that, by abutting of the engagement portions 17g against the regulation surfaces, the welded surface W formed by the right-side wall 14b of the shield case 14 and the third portion 17c of the shield plate 17 is defined. Preferably, the welded surface W is defined so that the lower end edge of the right-side wall 14b and the front end edge of the third portion 17c form the same plane. The pair of engagement portions 17g are an example of the positioning portion.

According to the above-described configuration, welding can be performed to the welded surface W in the state in which the displacement of the shield plate 17 with respect to the shield case 14 is regulated in the up direction. As a result, reduction in welding quality attributed to the positional displacement of both can be restrained. In particular, when assembly and welding of the shield plate 17 to the shield case 14 are performed in a state in which the regulation direction matches the vertical lower direction as illustrated in FIG. 8, no jig for making the shield plate 17 abut the regulation surface is required. Accordingly, the manufacturing apparatus and the manufacturing process can be simplified, which can restrain increase in manufacturing cost of the transformer 10.

Note that the shape of the member that relates to the regulation of the displacement of the shield plate 17 with respect to the shield case 14 in the up direction can be changed as needed. For example, the shield case 14 may be provided with an arm portion extending in the left-right direction, and the arm portion may be provided with a regulation surface facing the down direction. In this case, the shield plate 17 may be provided with a step portion abutting the above-mentioned regulation surface.

In the above-described exemplary embodiment, a plurality of welded surfaces W are formed in separate positions. However, a single continuous welded surface W may be formed, depending on the specification of the shield case 14 and the shield plate 17.

Next, the following describes an embodiment in which the transformer 10, constituted in the above manner, is a board mounting part to be mounted on a circuit board, with reference to FIG. 23 to FIG. 26. In this case, the terminal for mounting 162 is an example of a first portion of a conductive terminal. The terminal for coil 161 is an example of a second portion of the conductive terminal.

As illustrated in FIG. 23, the conductive wire 12 is wound around the terminal for coil 161. Specifically, the conductive wire 12 is wound around the terminal for coil 161 so as to include a first-layer turn 121 and a second-layer turn 122.

The second-layer turn 122 is positioned at a more outer peripheral side than the first-layer turn 121. The first-layer turn 121 is wound in a clockwise direction when viewed from a front end side of the terminal for coil 161. The second-layer turn 122 is wound in a counterclockwise direction when viewed from the front end side of the terminal for coil 161. That is, the winding direction of the first-layer turn 121 is reverse to the winding direction of the second-layer turn 122. The clockwise direction is an example of a first direction. The counterclockwise direction is an example of a second direction.

As illustrated in FIG. 24, the conductive wire 12 is wound around the terminal for coil 161 so as to form a plurality of first-layer turns 121. The plurality of first-layer turns 121 are formed to be aligned along a length direction of the terminal for coil 161.

As illustrated in FIG. 23 and FIG. 24, the terminal for coil 161 includes a convex portion 161a. The convex portion 161a is formed on a side surface 161c which is different from the front end surface 161b of the terminal for coil 161. The convex portion 161a has a surface extending to intersect a direction in which the plurality of first-layer turns 121 are aligned. After the plurality of first-layer turns 121 are formed, the conductive wire 12 reverses its winding direction by being hung on the convex portion 161a.

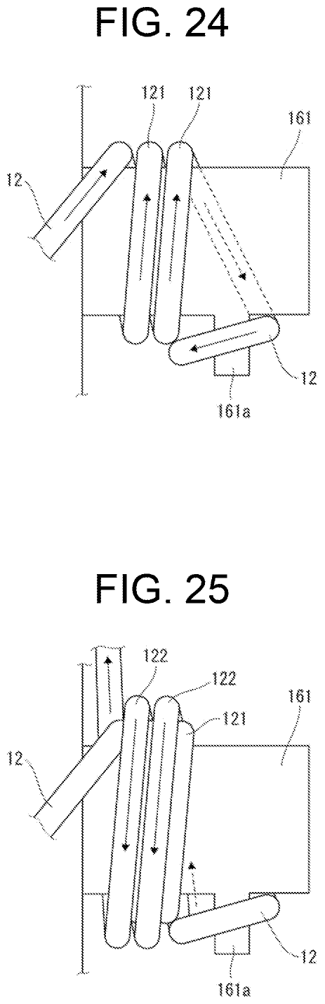

Subsequently, as illustrated in FIG. 25, the conductive wire 12 is wound around the terminal for coil 161 so as to form a plurality of second-layer turns 122. The plurality of second-layer turns 122 are formed to be aligned along the length direction of the terminal for coil 161. The plurality of second-layer turns 122 are formed to cover at least a part of the plurality of first-layer turns 121.

After the plurality of second-layer turns 122 are formed, the conductive wire 12 is relayed to an other terminal for coil 161. The above-described winding method is adopted, except for the terminal for coil 161 at which the terminal end of the conductive wire 12 is positioned.

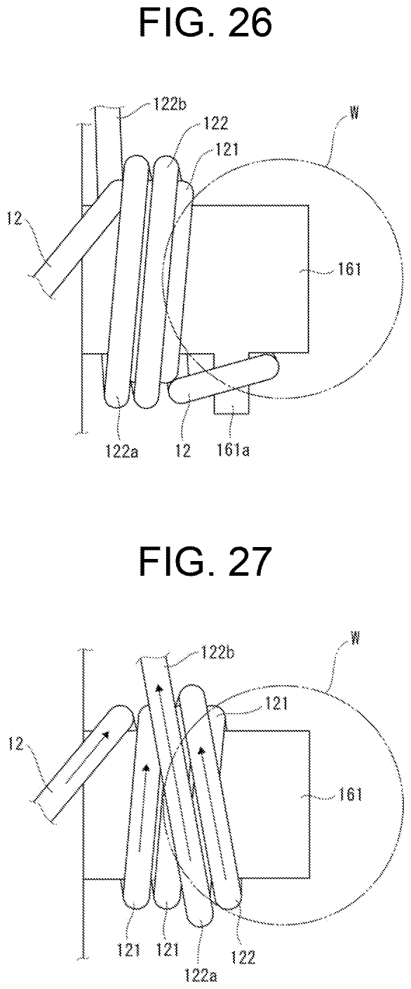

Subsequently, as illustrated in FIG. 26, the conductive wire 12 is bonded to the terminal for coil 161. In the present exemplary embodiment, the bonding is performed by laser welding. Note that TIG welding may be used in place of laser welding. The thermofused terminal for coil 161 and conductive wire 12 form the welded portion W1. The welded portion W1 is an example of a bonded portion.

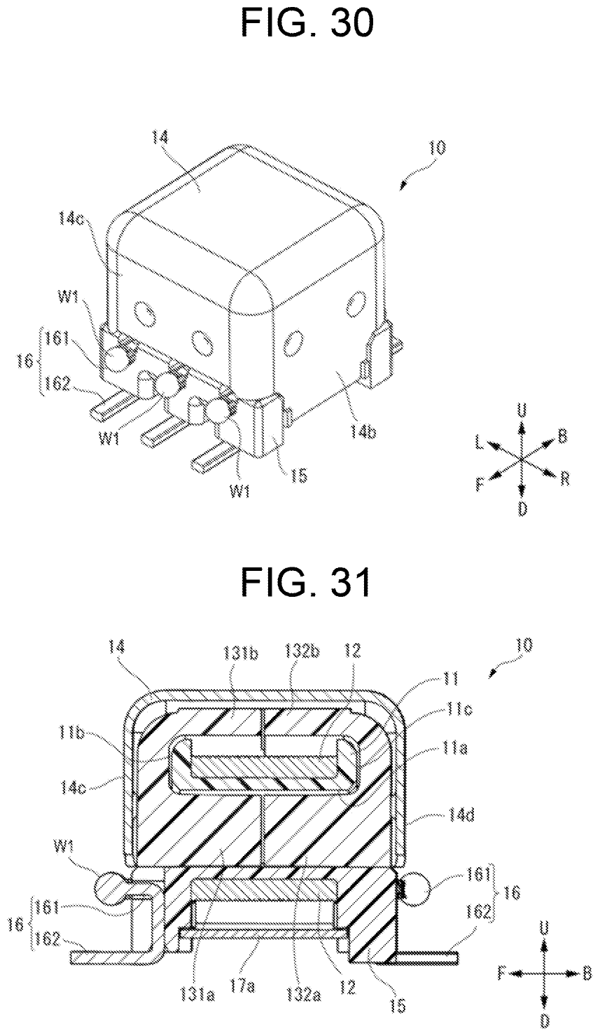

As illustrated in FIG. 30 and FIG. 31, the welded portion W1 is positioned at a front end portion of each terminal for coil 161. As illustrated in FIG. 26, at least the final turn 122a, included in the plurality of second-layer turns 122, is separated from the welded portion W1.

FIG. 27 illustrates a winding method of a conductive wire 12 according to a comparison example. In the present example, the plurality of second-layer turns 122 are formed, without reversing the winding direction after the plurality of first-layer turns 121 are formed.

According to this winding method, the extending direction of the conductive wire 12 which forms the second-layer turn 122, intersects the extending direction of the conductive wire 12 which forms the first-layer turn 121. In this case, the second-layer turn 122 overlapping the first-layer turn 121 is liable to sideslip in the width direction of the conductive wire 12, and therefore stability of the winding state is hard to maintain.

In addition, at least the final turn 122a, included in the plurality of second-layer turns 122, is included in the welded portion W1. In this case, when a stress that would displace a part 122b of the conductive wire 12, used to relay to an other terminal for coil 161, is exerted, the conductive wire 12 may break at a connected portion with the welded portion W1, at which rigidity is relatively high.

On the other hand, according to the winding method according to the present exemplary embodiment, the extending direction of the conductive wire 12 which forms the second-layer turn 122 can be the same as the extending direction of the conductive wire 12 which forms the first-layer turn 121. Accordingly, the second-layer turn 122 can be wound along between two adjacent first-layer turns 121, and therefore is restrained from sideslipping in the width direction of the conductive wire 12. As a result, the stability of the winding state is easier to maintain.

In addition, since at least a part of the final turn 122a, included in the plurality of second-layer turns 122, is separated from the welded portion W1, it is possible to restrain a stress that would displace a part 122b of the conductive wire 12, used to relay to an other terminal for coil 161, from being conveyed to the connected portion with the welded portion W1, at which rigidity is relatively high. As a result, breakage of the conductive wire 12 attributed to that stress is restrained.

Therefore, reduction in performance of the transformer 10 attributed to conduction failure can be restrained.

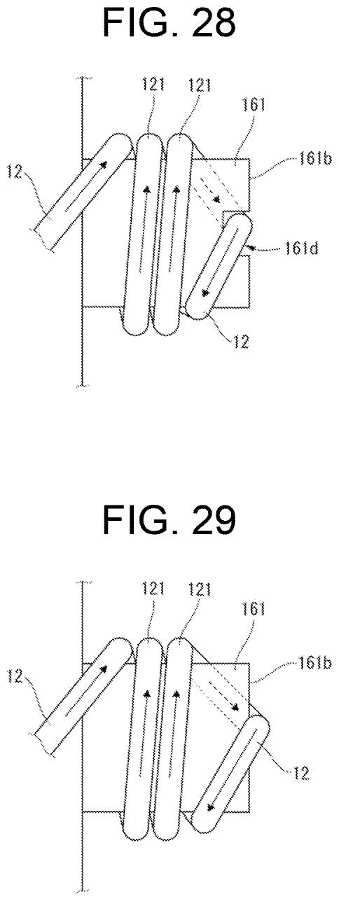

FIG. 28 illustrates another example of a shape of the terminal for coil 161. In the present example, a concave portion 161d is formed on the front end surface 161b of the terminal for coil 161. The concave portion 161d has a surface that extends to intersect the direction in which the plurality of first-layer turns 121 are aligned. In the present embodiment example, too, the winding direction of the conductive wire 12 is reversed on this surface.

That is, if it is possible to form a surface that extends to intersect the direction in which the plurality of first-layer turns 121 are aligned, so as to reverse the winding direction of the conductive wire 12, it is also possible to provide at least one of the convex portion and the concave portion in an appropriate position in the terminal for coil 161.

FIG. 29 illustrates another example of the shape of the terminal for coil 161. In the present example, the winding direction of the conductive wire 12 is reversed on the front end surface 161b of the terminal for coil 161. The front end surface 161b is an example of a surface that extends to intersect the direction in which the plurality of first-layer turns 121 are aligned. That is, provision of at least one of the convex portion and the concave portion is not always necessary in order to reverse the winding direction of the conductive wire 12.

In the present exemplary embodiment, the terminal for coil 161 is bonded to the conductive wire 12 by welding. However, the terminal for coil 161 may be soldered to the conductive wire 12. In this case, the solidified solder fillet corresponds to the above-described welded portion W1. The solidified solder fillet is an example of a bonded portion.

The above-described winding method of the conductive wire is applicable to an appropriate board mounting part having a configuration which has a plurality of conductive terminals electrically coupled to contacts formed on a circuit board, and in which a conductive wire is wound around the conductive terminal. Some examples of such board mounting part are a motor and an actuator.

Each configuration referenced so far is for illustrative purposes only to facilitate understanding of the present disclosure. Each configuration example can be changed or combined with other configuration example(s), as needed, within the scope of the spirits of the present disclosure.

In the above-described embodiments, the pair of front convex portions 181 and the pair of back convex portions 182 sandwich the first core 131 and the second core 132, at a same height position as viewed from the front-back direction or the left-right direction of the transformer 10. However, as long as a symmetrical fastening force can be exerted to the first core 131 and the second core 132 from the front-back direction of the transformer 10, the position of each convex portion can be changed as needed.

In the above-described embodiments, the pair of left convex portions 183 and the pair of right convex portions 184 sandwich the first core 131 and the second core 132, at the same height position as viewed from the front-back direction or the left-right direction of the transformer 10. However, as long as a symmetrical fastening force can be exerted to the first core 131 and the second core 132 from the left-right direction of the transformer 10, the position of each convex portion can be changed as needed.

In the above-described exemplary embodiments, each of the front convex portions 181, the back convex portions 182, the left convex portions 183, and the right convex portions 184 is formed as a part of the shield case 14 by performing machining on the shield case 14. However, as long as having a desired fastening capability directed to the first core 131 and the second core 132, the shield case 14 may be provided with, as a separate body, at least one of the front convex portions 181, the back convex portions 182, the left convex portions 183, and the right convex portions 184.

As long as a shield case 14 having a slitless box shape can be provided, other methods than drawing can be adopted. In one of such examples, the shield case 14 may be formed by folding a plate material and bonding the end surfaces with each other. In an other of such examples, die casting may be adopted to form the shield case 14 from a copper alloy, an aluminum alloy, or the like. Having excellent productivity, this manufacturing method is able to restrain increase in manufacturing cost, while maintaining the desired characteristics by forming the shield case 14 in the same shape as those made by drawing.

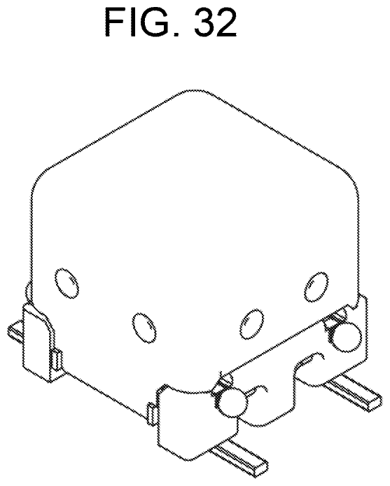

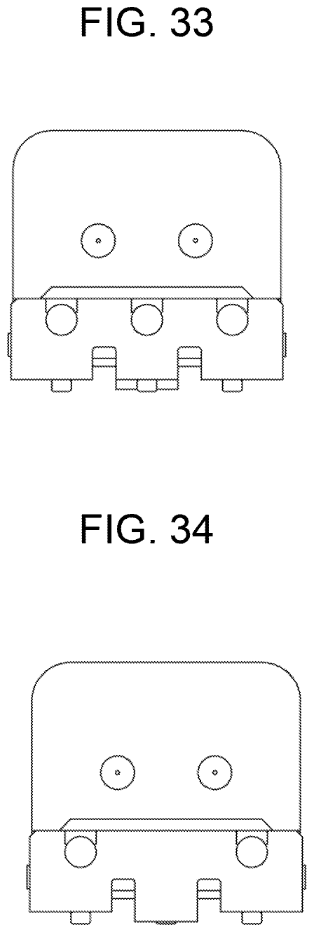

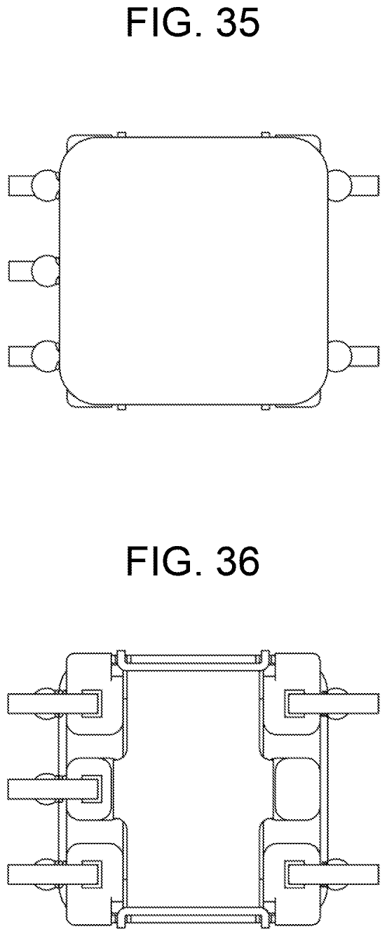

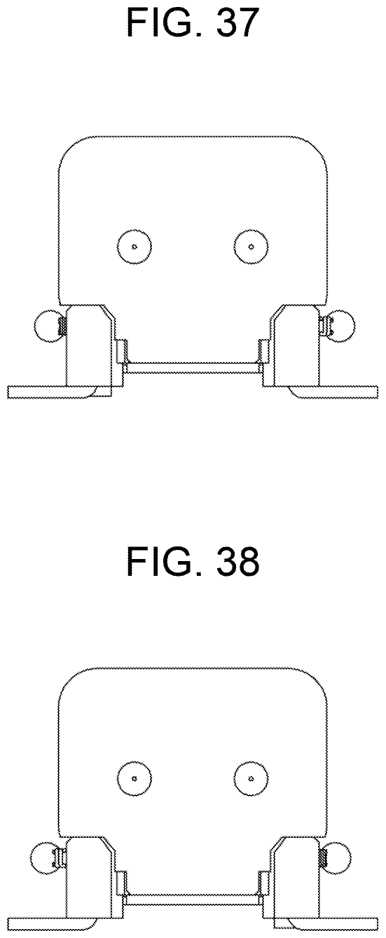

Designs of the transformers according to the exemplary embodiments described with reference to FIG. 1 to FIG. 31 are illustrated in FIG. 32 to FIG. 38. FIG. 32 is a perspective view. FIG. 33 is a front view. FIG. 34 is a back view. FIG. 35 is a plan view. FIG. 36 is a bottom view. FIG. 37 is a left-side view. FIG. 38 is a right-side view.

What is claimed is:

1. A transformer comprising:
a core portion having a hollow portion extending in a first direction;
a conductive wire wound around the core portion;
a first core formed by a material including a magnetic substance, the first core including:
a first inner portion extending from one end of the core portion in the first direction to inside the hollow portion; and
a first outer portion opposing the conductive wire, at least from a second direction orthogonal to the first direction, and a third direction orthogonal to the first direction and the second direction;
a second core formed by a material including a magnetic substance, the second core including:
a second inner portion extending from an other end of the core portion in the first direction to inside the hollow portion; and
a second outer portion opposing the conductive wire from the second direction and the third direction;
a shield case formed by a material that has conductive properties, and having a box shape surrounding the first core and the second core from the first direction, the second direction, and the third direction;
a first sandwiching member provided on an inner wall surface of the shield case, and sandwiching the first core and the second core along the first direction; and
a second sandwiching member provided on the inner wall surface, and sandwiching the first core and the second core along the second direction.

2. The transformer according to claim 1, wherein
each of the first outer portion of the first core and the second outer portion of the second core includes a rounded corner portion opposing the inner wall surface.

3. The transformer according to claim 1, wherein
the shield case is formed slitless by drawing.

4. The transformer according to claim 1, wherein
the shield case is formed by aluminum.

5. A transformer comprising:
a core portion having a hollow portion extending in a first direction;
a conductive wire wound around the core portion;
a first core formed by a material including a magnetic substance, the first core including:
a first inner portion extending from one end of the core portion in the first direction to inside the hollow portion; and
a first outer portion opposing the conductive wire, at least from a second direction orthogonal to the first direction, and a third direction orthogonal to the first direction and the second direction;
a second core formed by a material including a magnetic substance, the second core including:
a second inner portion extending from an other end of the core portion in the first direction to inside the hollow portion; and
a second outer portion opposing the conductive wire from the second direction and the third direction;
a shield case formed by a material that has conductive properties, and having a box shape surrounding the first core and the second core from the first direction, the second direction, and the third direction; and
a sandwiching member provided on an inner wall surface of the shield case, and sandwiching the first core and the second core along the first direction.

6. The transformer according to claim 5, wherein
the sandwiching member sandwiches the first core and the second core at a same height position as viewed from the first direction or the second direction.

7. The transformer according to claim 5, wherein
each of the first outer portion of the first core and the second outer portion of the second core includes a rounded corner portion opposing the inner wall surface.

8. The transformer according to claim 5, wherein
the shield case is formed slitless by drawing.

9. The transformer according to claim 5, wherein
the shield case is formed by aluminum.

10. A transformer comprising:
a core portion having a hollow portion extending in a first direction;
a conductive wire wound around the core portion;
a first core formed by a material including a magnetic substance, the first core including:
a first inner portion extending from one end of the core portion in the first direction to inside the hollow portion; and
a first outer portion opposing the conductive wire, at least from a second direction orthogonal to the first direction, and a third direction orthogonal to the first direction and the second direction;
a second core formed by a material including a magnetic substance, the second core including:
a second inner portion extending from an other end of the core portion in the first direction to inside the hollow portion; and
a second outer portion opposing the conductive wire from the second direction and the third direction;
a shield case formed by a material that has conductive properties, and having a box shape surrounding the first core and the second core from the first direction, the second direction, and the third direction; and
a sandwiching member provided on an inner wall surface of the shield case, and sandwiching the first core and the second core along the second direction.

11. The transformer according to claim 10, wherein
the sandwiching member sandwiches the first core and the second core at a same height position as viewed from the first direction or the second direction.

12. The transformer according to claim 10, wherein
each of the first outer portion of the first core and the second outer portion of the second core includes a rounded corner portion opposing the inner wall surface.

13. The transformer according to claim 10, wherein
the shield case is formed slitless by drawing.

14. The transformer according to claim 10, wherein
the shield case is formed by aluminum.
